(19) United States
(12) Patent Application Publication
(10) Pub. No.: US 2026/0364676 A1
(43) Pub. Date: Nov. 19, 2026

(54) A PRODUCT AND METHOD FOR THICK-WALLED CAPPED GOLD NANOTUBES

(71) Applicant: AuNano AB, Norrköping (SE)

(72) Inventors: Klas Oskar TYBRANDT, Linköping (SE); Laura Susanne SAVVAKIS, Norrköping (SE); Yuyang LI, Norrköping (SE)

(21) Appl. No.: 19/477,682

(22) PCT Filed: Apr. 24, 2024
(86) PCT No.: PCT/SE2024/050392

§ 371 Date: Oct. 22, 2025

(30) Foreign Application Priority Data
Apr. 26, 2023 (SE) 2350502-7

(51) Int. Cl. B22F 1/054; B22F 1/145; B22F 9/24; H01B 1/02

(52) U.S. Cl. CPC B22F 1/0547; B22F 1/0549; B22F 1/145; B22F 9/24; H01B 1/02; B22F 2301/255; B22F 2304/05; B22F 2998/10

(57) ABSTRACT

The present disclosure relates to a method (300) for producing thick-walled capped Au nanotubes (100). The method (300) comprises the steps of a. forming (310) a first solution comprising metal nanowires (110), and a first solvent, wherein the metal nanowires (110) is of a first metal comprising silver and/or copper; b. adding (320) a first Au complex to the first solution, thereby inducing galvanic displacement of the first metal by gold, and/or chemical reduction of said first Au complex to coat the metal nanowires (110) with gold to form Au nanotubes (120 ) around the metal nanowires (110); and c. adding (360) a second Au complex, and a growth directing agent to the first solution, thereby growing gold at the Au nanotubes (120) to form the thick-walled capped Au nanotubes (100). Growing gold on the Au nanotubes after step c (360) is maintained for at least 1 min. A dispersing agent is added to the first solution in step a and/or step b. A reducing agent is added to the first solution in step a, step b and/or step c.

### TECHNICAL FIELD

The present disclosure relates to nanotube production, gold nanotubes, and sacrificial template methods.

### BACKGROUND

Metal nanowires, such as Ag nanowires, have been widely used as high aspect ratio nano-structures in transparent electrodes and stretchable conductors but are not chemically stable. Au nanowires are a biocompatible alternative that can offer high conductivity and stretchability, but to date there exists no high aspect ratio Au nanostructures that can be of synthesized in large amounts with a robust method. Previous transparent electrodes and stretchable composites have used Ag nanowires coated with a layer of Au. When exposed to corrosive conditions or mechanical wear such Ag nanowires coated with Au deteriorate and can release silver that may cause undesired reactions. To date there is no Au equivalent to the widely available and utilized Ag nanowires.

There is a need improve providing long-term stable high aspect ratio nano-structures that do not corrode, tarnish or oxidise.

### SUMMARY

Currently, straightforward production of significant amounts of nanowires suitable for electronics applications is only available in metals that are sensitive to the environment and readily degrade by oxidation, corrosion, UV and tarnishing, such as silver and copper. The invention relates to utilizing nanowires of said metals as a sacrificial template for producing nanotubes of metals less prone to degrading with properties suitable for electronics applications, wherein the sacrificial template is removed from and/or entombed in the final Au nanotube.

The invention relates to a novel synthesis of high aspect ratio Au nanotubes with smooth surface structure and narrow size distribution of the nanotube diameter. The process uses metal nanowires, such as silver or copper, as the template. During a first and a second gold coating step most of the metal nanowire template is removed. Final nanotubes have shown to contain 99% weight % (wt%) Au and shows stability under corrosive conditions. The process allows for selective control of the Au nanotube diameter by variations in initial Au nanotube concentration and Au complex and dispersing agent concentrations in the second coating step. Initial Au complex concentration limit the amount of Au that can be deposited on the Au nanotubes. The dispersing agent concentration affects both the thickness and evenness of the Au coating, as well as the distribution of Au nanotube diameters after the synthesis. Using polyvinylpyrrolidone, PVP, as dispersing agent at concentration from 1 wt % to 25 wt % have been used, with best coating evenness and narrow diameter distribution for ≥5 wt % PVP. Also, the temperature (T) impacts the second gold coating step, with T≥60 °C giving much faster growth than at room temperature. The impact of pH may also depend on the gold complex used and the reducing agent. For the reducing agent ascorbate, pH>7 have been used with good results. During the second growth step, pH in the range of 2-9 have provided satisfactory results.

One object of the invention is to provide stable gold nanotubes with capped ends. As gold nanotubes have a hollow core, the end of the tube can either be open so that the hollow interior of the tube is in contact with the surrounding medium, or closed off by a lid of gold which thereby blocks the end of the tube. The latter situation is what here is called “capped ends” or capped nanotubes. There are several advantages of capped nanotubes, for example prevents the cap leakage of undesirable substances from the hollow core which may originate from processing or from residues of the growth template. One should note that such purity aspects are very important in biomedical applications and for preserving long-term stability in applications where trace amounts of chemical species can induce deteriorating performance, for example in sensitive interfaces in optoelectronic devices like light emitting diodes or solar cells. The cap also defines the accessible surface area of the tube, while tubes with an open end have a large partially accessible inner area which may contribute to less distinct electrochemical responses of the tubes. A cap might further stabilize the nanotube structure and prevent the decomposition into nanoparticles which has been observed for thin-walled gold nanotubes without cap.

This has in accordance with the present disclosure been achieved by means of a method for producing thick-walled capped Au nanotubes. The method 300 comprises the steps of
a. forming a first solution comprising metal nanowires, and a first solvent, wherein the metal nanowires is of a first metal comprising silver and/or copper;
b. adding a first Au complex to the first solution, thereby inducing galvanic displacement of the first metal by gold, and/or chemical reduction of said first Au complex to coat the metal nanowires with gold to form Au nanotubes around the metal nanowires; and
c. adding a second Au complex, and a growth directing agent to the first solution, thereby growing gold at the Au nanotubes to form the thick-walled capped Au nanotubes.

Growing gold on the Au nanotubes after step c is maintained for at least 1 min.

A dispersing agent is added to the first solution in step a and/or step b.

A reducing agent is added to the first solution in step a, step b and/or step c.

This has the advantage of providing a robust synthesis method for Au nanotubes that has the possibility of upscaling. This further has the advantage of highly conductive and stable Au nanotubes for applications where combinations of electrical conductivity, mechanical flexibility, large surface area, stability, corrosion resistance and optical transparency are needed.

In some embodiments, the method comprises, after step b, adding an etchant for the first metal to the first solution, thereby removing residual first metal.

This has the advantage of allowing gold growth after step c to be carried out with at least some metal of the nanowire removed from the Au nanotubes formed around the metal nanowires grown after step b.

In some embodiments, the method comprises, after step b, adding a first complexing agent arranged to bind the first metal, thereby inducing dissolution of any salts of the first metal.

This has the advantage of allowing gold growth after step c to be carried out without metal salts in the first solution.

In some embodiments, the method comprises, after step b, performing dialysis, sedimentation and solvent exchange, and/or centrifugation solvent exchange, thereby cleaning the Au nanotubes. This further has the advantage of removing any metal of the nanowire and/or corresponding metal salts that have been brought up into the solution by for example etching and/or dissolving said metals and metal salts after step b.

This has the advantage of allowing gold growth after step c to be carried out with old solution and species from step b removed from the first solution, thus allowing for first solution condition for the second gold growth after step c that are substantially independent of the first solution conditions after step b.

In some embodiments, the method comprises, after step c, adding a second complexing agent arranged to bind the first metal, thereby induce dissolution of any salt of the first metal.

This has the advantage of allowing any metal salts deposited on the thick-walled capped Au nanotubes to be removed.

In some embodiments the method comprises, after step c, performing dialysis, sedimentation and solvent exchange, and/or centrifugation solvent exchange, thereby cleaning the thick-walled capped Au nanotubes.

This has the advantage of allowing any species in the first solution that are not desired in the final the thick-walled capped Au nanotube product to be removed. This further has the advantage of removing any remaining metal of the nanowire and/or corresponding metal salts that have been brought up into the solution by for example etching and/or dissolving said metals and metal salts after step c.

The present disclosure further relates to thick-walled capped Au nanotubes obtainable by process according to the method of claim 1, wherein the nanotubes have a ratio between outer diameter and inner diameter of at least 1.5, and wherein the ends of the nanotubes are capped with Au.

The present disclosure further relates to thick-walled capped Au nanotube. The Au nanotube has a difference between outer diameter and inner diameter of at least 10 nm. The nanotube has a ratio between outer diameter and inner diameter of at least 1.5. The ends of the nanotube are capped with Au. The gold content of the nanotube is at least 80 wt %.

This has the advantage of providing Au nanotubes with a high-aspect ratio structure that optical properties vary depending on the inner and outer diameter of the nanotube. This further allows for producing Au nanotubes with a thick wall, which improve stability in comparison to conventional thin-walled Au nanotubes, which tend to decompose into nanoparticles over time This further allows for producing thick-walled Au nanotubes comprising capped ends, which prevents absorption of surrounding media during processing, thus allowing control of the purity of the product. This further allows for producing thick-walled Au nanotubes comprising capped ends, which suppress leakage of metal residues from the core, thereby preserving the chemically stable and inert surface of the Au nanotubes.

In some embodiments, the thick-walled capped Au nanotube has the shape of a pentagonal prism. This may be advantageous as the surfaces of the pentagonal prism might be more energetically stable. Another advantage may be that the electrical contact in between Au nanotubes is improved by the pentagonal prism shape.

A solution comprising thick-walled capped Au nanotubes, wherein the solution comprises said thick-walled capped Au nanotubes, a dispersing agent and a solvent.

An Au nanotube composite, wherein the composite comprises a polymer and said thick-walled capped Au nanotubes, and wherein the composite comprises an electrically conductive network of said thick-walled capped Au nanotubes.

This has the advantage of allowing electrical conductivity throughout the network comprising Au nanotube film of Au nanotubes and polymer. This further allows conductivity of the film of Au nanotubes to be tuned by the density of tubes, the geometry of the tubes, and post treatment of the tubes like thermal or optical sintering. The combination of polymer and electrically conductive network of thick-walled capped Au nanotubes provides mechanical robustness to the Au nanotube film, thereby providing flexible or stretchable Au nanotube composites. When the binder in the composite is an elastomer, stretchable conductors based on Au nanotube-elastomer composites are formed. This further allows forming Au nanotube-PDMS composites that may have high conductivity and low Young's modulus and their use was demonstrated in in-vivo experiments.

This further has the advantage of providing Au nanotube-polymer composites, such as a nanotube-elastomer composite, that can combine high electrical conductivity with mechanical softness, Young's modulus below 10 MPa, non-toxicity and chemical stability, making them an excellent material for biomedical applications. Au nanotube-silicone elastomer composites comprising silicone elastomers are especially suited for biomedical applications, as both Au and silicone elastomers are chemically long-term stable and suitable for contact with biological tissue.

A transparent Au nanotube electrode, wherein the electrode comprises a substrate and said thick-walled capped Au nanotubes, wherein the electrode comprises an electrically conductive network of said thick-walled capped Au nanotubes arranged on the substrate.

In some embodiments, the electrically conductive network is partially embedded in a binder arranged to fixate the electrically conductive network at the substrate, and wherein the electrically conductive network is at least partially accessible from the environment.

This has the advantage of providing an electrode that is simultaneous electrical conduction and optical transparency. The sheet resistance of the transparent electrode decreases with Au nanotube density, while the optical transparency decrease with Au nanotube density. High-aspect ratio Au nanotubes may be beneficial for high performance transparent electrodes with good transparency, such as above 90 wt %, and low sheet resistance, such as below 10 ohm/square. This further allows for transparent conducting electrodes are used in a wide range of optoelectronic devices like displays, where the light needs to pass through a conductive layer. The thick-walled capped Au nanotubes can be combined with other transparent conductive materials like graphene, carbon nanotubes and conducting polymers, such as poly (3,4-ethylenedioxythiophene), PEDOT, to form a transparent conductive electrode that comprises several conductive materials. Transparent conducting electrodes comprising Au nanotubes may also be used in opto-electrochemical applications that couples light and electrical conduction with electrochemistry. This further has the advantage of providing a high internal surface area for a thick, at least 0.5 μm, Au nanotube electrode. The high internal surface area is advantageous in electrochemical applications for charge storage and electrocatalysis. The high surface area Au nanotube electrode can form a porous freestanding electrode, which enables flow of liquid or gas through the film, which is of interest in electrocatalysis and sensing applications.

### BRIEF DESCRIPTION OF THE DRAWINGS

FIG. 1a-d shows schematically steps of growing a thick-walled Au capped nanotube at a metal nanowire.

FIG. 2a-d depicts schematically conductive networks of Au nanotubes in transparent electrodes.

FIG. 3 illustrates a method for growing an Au nanotube from an Ag nanowire.

FIG. 4 depicts a SEM image of Au nanotubes.

FIG. 5 depicts a SEM image of Au nanotubes broken off showing hollow interiors.

### DETAILED DESCRIPTION

Throughout the figures, same reference numerals refer to same parts, concepts, and/or elements. Consequently, what will be said regarding a reference numeral in one figure applies equally well to the same reference numeral in other figures unless explicitly stated otherwise.

### Terms and Expressions

The term nanowire relates to nanostructures in the form of a wire with the diameter of the order of single to hundreds of nanometres.

The term nanotube relates to nanometre scale tubular structures, such as a nanowire with hollow core. Typically, nanotubes have a specific surface area of several square meters per gram, thereby allowing for significantly larger area for interactions compared to flat surfaces of larger structures.

The term capped nanotube relates to a nanotube that is closed at the ends. Typically, the material of the caps at the ends of the nanotube is of the same material as the nanotube. It is to be understood that the capped nanotube may have been capped before the tube part of the capped nanotube was fully-grown. Typically, large numbers of nanotubes are produced at once, therefore a method for producing capped nanotube is to be understood as a being a method that produces a significant number of capped nanotubes, correspondingly it is to be understood that a method for producing non-capped nanotubes may, due to the inherent randomness when growing nanotubes, in theory occasionally form a capped nanotube.

The expression “solution” relates to a formed solution and the solution with additions. For example, a first solution is formed with Ag nanowires in water, and is still named the first solution after addition of a first Au complex. In this example, mixing a second Au complex and a reducing agent in a second solvent would be named a second solution, and the solution formed by adding the second solution to the first solution would typically be called the first solution.

The term gold complex relates to coordination compounds containing one or more gold atoms. For example, a gold complex may be a gold salt or its corresponding form in a solvent. Typically, a gold complex may be reduced so that the comprised gold is deposited in solid form.

The term gold salt relates to a compound that contains gold ions.

The term dispersing agent relates to a substance that helps to keep particles from clumping together. For example, during gold nanotube production, a dispersing agent may be used to prevent the gold nanotubes from aggregating.

The term growth directing agent relates to a substance that helps to control the shape and size of nanoparticles during their formation. For example, during gold nanotube production, a growth directing agent may be used to control the surface structure, shape and size of the gold nanotubes. It is to be understood that some substances have the ability to function both as a dispersing agent and as a growth directing agent.

The term reducing agent relates to a substance that donates electrons to another substance during a chemical reaction. For example, during gold nanotube production, a reducing agent may be used to reduce gold ions in a gold salt to form gold nanotubes.

The term galvanic displacement relates to a process in which one kind of metal ions is reduced by the oxidation of other metal atoms. For example, during gold nanotube production, galvanic displacement may be used to deposit gold onto a template nanowire made of another metal such as silver or copper to form gold nanotubes.

The term complexing agent relates to a substance that forms a complex with a metal ion and thereby increase the solubility of the metal ion. For example, growing gold nanotubes on silver nanowires may form AgCl, and the AgCl may be dissolved by a silver complexing agent, such as ammonia or sodium thiosulfate. For example, ethylenediaminetetraacetic acid may be used as a copper complexing agent.

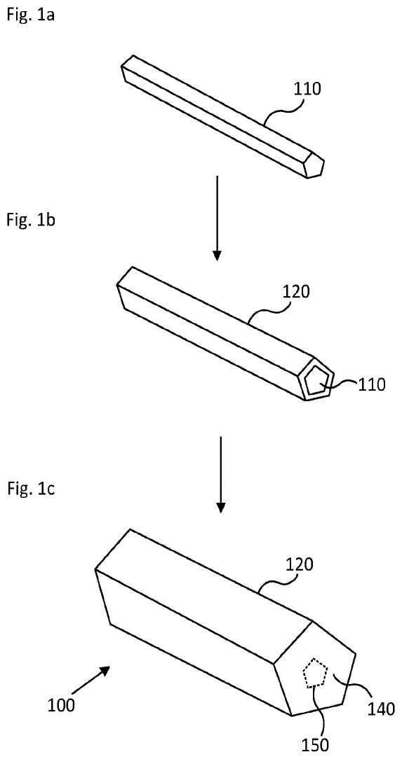

FIG. 1a-c depicts schematically steps of producing a thick-walled capped Au nanotube 100 from a nanowire 110, for example utilizing a sacrificial template method based on galvanic replacement and/or chemical reduction of a gold complex. FIG. 1a depicts the starting material of nanowire 110, FIG. 1c depicts the produced thick-walled capped Au nanotube 100, and FIG. 1b depicts an intermediary step with an Au nanotube 120 formed around a nanowire 110. In FIG. 1c, the cap 140 covers the hollow interior 150 of the capped Au nanotube.

FIG. 1a shows an example metal nanowire. Nanowires have a high aspect ratio. In some examples, the aspect ratio is at least 10, at least 100, or at least 1000. Typically, a large number of nanowires in solution are used to produce Au nanotubes.

Several types of nanowires are commercially available. In some examples, nanowires are produced in solution. For examples, Ag nanowires may be produced by polyol synthesis, and Cu nanowires may be produced by hydrazine reduction method.

Currently, straightforward production of significant amounts of nanowires suitable for electronics applications is only available in metals that are sensitive to the environment and readily degrade by oxidation, corrosion, UV and tarnishing, such as silver and copper. Therefore, nanowires of said metals may be suitable as a sacrificial template for producing nanotubes of metals less prone to degrading.

It is to be understand that the nanowire may be of silver, copper and/or another metal, or a combination of metals.

In some examples, the metal nanowire 110 is of a first metal comprising silver and/or copper. In some of these examples, the first metal is silver. In some of these examples, the first metal is copper.

Hereafter the metal nanowire 110 described in examples will be an Ag nanowire 110. It is to be understood that the examples described for Ag nanowires 110, such as chemicals used to etch silver, also relate to corresponding examples adapted for nanowires 110 of other metals or combinations thereof.

In some examples, the Ag nanowire 110 has a diameter in the range of 1-200 nm. In some of these examples, the Ag nanowire 110 has a diameter in the range 2-100 nm, 5-50 nm, 10-30 nm, 15-25 nm, or 7-60 nm.

In some examples, the Ag nanowire 110 has a length in the range of 1 μm-400 μm. In some of these examples, the Ag nanowire 110 has a length in the range of 2 μm-200 μm, 5 μm-100 μm, 7-50 μm, 10-30 μm, or 15-20 μm.

In some examples, the Ag nanowire 110 has a length of at least 1 μm.

In some examples, the Ag nanowire 110 has the shape of a pentagonal prism. That is to say that the length of the Ag nanowire 110 corresponds to the height of the pentagonal prism, such that at least some cross sections of the Ag nanowire 110 correspond to a pentagon.

In some examples, the Ag nanowire 110 has a cross section is pentagonal, cylindrical and/or is an intermediate rounded pentagonal.

In some examples, growing gold on the Ag nanowire 110 shaped as a pentagonal prism may result in the thick-walled capped Au nanotube 100 having a contour corresponding to a pentagonal prism. In some of these examples, the thick-walled capped Au nanotube 100 has the contour of a pentagonal prism.

In some examples, the Au nanotube cap 140 consists of at least 90 wt % Au, at least 95 wt %, or at least Au, or 99 wt % Au.

In some examples, the thickness of the Au nanotube cap 140 is larger than the inner radius of the nanotube. In some examples, the thickness of the Au nanotube cap 140 is larger than the inner diameter of the nanotube. In some examples, the thickness of the Au nanotube cap 140 is larger than two times the inner diameter of the nanotube. In some examples, the thickness of the Au nanotube cap 140 is larger than three times the inner diameter of the nanotube.

In some examples, the shape of the Au nanotube cap 140 is elongated, wherein the distance from the end of the cap to the nanotube interior hollow core is larger than the outer diameter of the nanotube. In some of these examples, the distance is larger than half the outer diameter of the nanotube.

In some examples, the shape of the Au nanotube cap 140 is elongated, such that the distance from the end of the cap to the nanotube interior hollow core is larger than two times the outer diameter of the nanotube.

In some examples, the shape of the Au nanotube cap 140 is elongated, such that the distance from the end of the cap to the nanotube interior hollow core is larger than the inner diameter of the nanotube.

In some examples, the shape of the Au nanotube cap 140 is elongated, such that the distance from the end of the cap to the nanotube interior hollow core is larger than 10 nm, 20 nm 30 nm, 50 nm or 100 nm.

In some examples, thick-walled capped Au nanotubes have thick walls and caps arranged to prevent leakage of undesirable substances from the interior hollow core. The content of the interior hollow core may originate from processing or from residues of the growth template.

In some examples, thick-walled capped Au nanotubes are arranged for making composites of the capped Au nanotubes and a polymer binder, as solvent or polymer precursors can be absorbed within the hollow core and later be released out when using nanotubes without capped ends.

In some examples, thick-walled capped Au nanotubes are arranged to prevent leakage from the hollow core to the environment, so as to be usable in biomedical applications.

In some examples, thick-walled capped Au nanotubes are arranged to prevent leakage from the hollow core, thus providing long term stability when capped Au nanotubes are used as interface to sensitive active layers in for example light emitting diodes or photovoltaic cells. The release of undesirable chemical species or ions from within nanotubes may degrade the active layer(s) in such applications.

In some examples, thick-walled capped Au nanotubes comprising high purity capped Au nanotubes can reduce leakage of other trace elements in sensitive applications including biomedical, light emitting diodes and photovoltaic cells.

In some examples, thick-walled capped Au nanotubes, comprising high purity capped Au nanotubes can be used in applications where contact with human or non-human animal skin is expected. The inertness of gold prevents allergic reactions, which may be an issue with other less inert metals like nickel or copper.

In some examples, thick-walled capped Au nanotubes are arranged to have improved structural stability over tubes with thin walls or without cap, as thick-walled capped Au nanotubes do not have any thin exposed surfaces that are prone to structural decomposition over time. In contrast, decomposition into nanoparticles have been observed for thin-walled gold nanotubes without cap.

In some examples, thick-walled capped Au nanotubes comprise a well-defined surface area which can be an advantage in electrochemical applications. Non-capped tubes provide slow access to their interior surface area, which provides a less distinct electrochemical response compared to capped tubes that only allow access to the outer surface.

In some examples, thick-walled capped Au nanotubes have capped ends that are advantageous over open ends when interfacing biological tissue or cells, as the capped ends provide a smoother and more stable interface.

FIG. 1b shows an example thin-walled Au nanotube 120 formed around an Ag nanowire 110. In this example, gold has been grown at an Ag nanowire 110 by reducing a gold complex and by galvanic replacement of silver by gold. The Ag nanowire 110 may be an Ag nanowire 110 as described in FIG. 1a.

In some examples, the Au nanotube 120 formed around an Ag nanowire 110 has a relatively thin gold layer, wherein the combined Au nanotube 120 and Ag nanowire 110 contains at least 10 wt % silver. In some of these examples, wherein the combined Au nanotube 120 and Ag nanowire 110 has a silver content of at least 15 wt %, at least 20 wt %, at least 25 wt %, at least 30 wt %, at least 40 wt %, or at least 50 wt %.

In some examples, the Au nanotube 120 formed around an Ag nanowire 110 has a difference between outer diameter and inner diameter of at most 50 nm. In some of these examples, the Au nanotube 120 formed around an Ag nanowire 110 has a difference between outer diameter and inner diameter of at most 40 nm, at most 30 nm, at most 20 nm, at most 15 nm, at most 10 nm, or at most 5 nm.

In some examples, the Au nanotube 120 formed around an Ag nanowire 110 has a difference between outer diameter and inner diameter of at least 5 nm.

In some examples, going from the Ag nanowire 110 in FIG. 1a to the Au nanotube 120 formed around the Ag nanowire 110 relates to performing a first step of gold growth on the Ag nanowire 110. In some of these examples, the first step of gold growth utilizes galvanic replacement of silver with gold, and/or chemical reduction of a first gold complex.

It is to be understood that even though the thin-walled Au nanotube 120 illustrated in FIG. 1b is drawn with a solid tube wall, produced thin-walled Au nanotubes are typically porous or patchy such that even if the ends were capped the metal nanowire 110 would be accessible to the environment.

FIG. 1c shows an example thick-walled capped Au nanotube 100 formed by a step of growing gold on the Au nanotube 120 in FIG. 1b.

In some examples, the thick-walled capped Au nanotube 100 are formed by performing a second step of gold growth on the Au nanotube 120 formed around an Ag nanowire in FIG. 1b. In some of these examples, the first step of gold growth utilizes chemical reduction of second gold complex. In a preferred example, gold is grown at the Au nanotube 120 to form the thick-walled capped Au nanotube 100 under different conditions than gold is grown at the Ag nanowire 110 to form Au nanotube 120, such as by performing solvent exchange and/or removing silver and silver salts.

It is to be understood that in the process of forming a plurality of thick-walled capped Au nanotube from Ag nanowires via a plurality of Au nanotubes formed around said Ag nanowires, as shown in FIG. 1a-b, a significant fraction of the Au nanotubes forms caps 140 at the end of the Au nanotubes 120. The thick-walled capped Au nanotubes 100 may enclose, or at least significantly reduce access from the environment, to any silver or silver salts remaining inside the Au nanotube 120, thereby reducing degradation and/or unwanted chemical interactions.

The thick-walled capped Au nanotube 100 comprises an Au nanotube 120 and a cap 140 at each end of the Au nanotube 120.

The Au nanotube 120 formed around an Ag nanowire 110 in FIG. 1b shows the end of the Ag nanowire 110 unobstructed. It is to be understood that upon performing a method to produce a plurality of such Au nanotubes 120 formed around an Ag nanowire 110 the resulting Au nanotubes may comprise some Au nanotubes having gold at least partially cover the ends of the Au nanotubes.

In FIG. 1c shows for illustrative purposes the contour of an opening 150 of the tube and/or Ag nanowire that was closed by the cap 140, wherein said contour of the capped opening 150 indicates the thickness of the thick-walled capped Au nanotube in relation to the diameter of the Ag nanowire. In this example, the diameter of the thick-walled capped Au nanotube 100 is approximately three times the diameter of the Ag nanowire 110.

It is to be understood that the Au nanotube 120 of the thick-walled capped Au nanotube 100 may be the Au nanotube 120 described in FIG. 1b with additional gold grown upon it.

In some examples, the thick-walled capped Au nanotube 100 restricts access to any silver and/or silver salts from the Ag nanowire in the Au nanotube 120. In some of these examples, the thick-walled capped Au nanotube 100 encloses said silver and/or silver salts.

After growing gold to form a plurality of Au nanotubes 120 formed around an Ag nanowires 110, or after growing gold to form a plurality of thick-walled capped Au nanotubes 100, the final product may be improved by removing silver and/or silver salts.

In some examples, the Ag nanowire 110 is etched away while growing the thick-walled capped Au nanotube utilizing an Ag etchant. In some of these examples the Ag etchant comprises concentrated nitric acid, iron(III) nitrate, KI/I₂/H₂O, and/or NH₄OH*:H₂O₂:H₂O/methanol. In some example utilizing a copper nanowire, copper is etched away with ammonium persulfate.

In some examples, the Au nanotubes 120 formed around Ag nanowires 110, and/or the thick-walled capped Au nanotubes 100 are exposed to a solution comprising ammonia arranged to dissolve silver salts.

In some examples, the thick-walled capped Au nanotube 100 is at least 80 wt % gold. In some of these examples, the thick-walled capped Au nanotube 100 gold content is at least 90 wt %, at least 95 wt %, at least 99 wt %, at least 99.5 wt %, or at least 99.9 wt %.

It is to be understood that the gold content of the thick-walled capped Au nanotube 100 is determined by also including any residual metal from the nanowire or salts thereof.

In some examples, the thick-walled capped Au nanotube 100 has a cross section contour that is pentagonal, cylindrical and/or is an intermediate rounded pentagonal.

In some examples, thick-walled capped Au nanotube 100 has an outer diameter of at least 30 nm. In some of these examples, the thick-walled capped Au nanotube 100 has an outer diameter of at least 40 nm, at least 50 nm, at least 60 nm, at least 80 nm, at least 100 nm, at least 120 nm, at least 150 nm, or at least 200 nm.

In some examples, thick-walled capped Au nanotube 100 has an outer diameter of at most 1 um. In some of these examples, the thick-walled capped Au nanotube 100 has an outer diameter of at most 500 nm, at most 300 nm, or at most 200 nm.

In some examples, thick-walled capped Au nanotube 100 has difference between outer diameter and inner diameter of at least 10 nm. In some of these examples, the thick-walled capped Au nanotube 100 has difference between outer diameter and inner diameter of at least 20 nm, at least 30 nm, at least 40 nm, at least 50 nm, at least 60 nm, at least 80 nm, at least 100 nm, at least 150 nm, or at least 200 nm.

In some examples, thick-walled capped Au nanotube 100 has an outer: inner diameter ratio, OD/ID, of at least 1.5. In some of these examples, the thick-walled capped Au nanotube 100 has an OD/ID of at least 1.7, at least 2, at least 2.5, at least 3, at least 4, at least 5, or at least 6.

In some examples, the thick-walled capped Au nanotube 100 has a length in the range of 100 nm-400 μm. In some of these examples, the Au nanotube 100 has a length in the range of 200 nm-200 μm, 500 nm-100 μm, 1-50 μm, 4-30 μm, or 10-20 μm.

In some examples, the thick-walled capped Au nanotube 100 has a length of at least 1 μm.

In some examples, thick-walled capped Au nanotube 100 has an aspect ratio of at least 50. In some of these examples, the thick-walled capped Au nanotube 100 has an aspect ratio of at least 100, at least 200, at least 400, at least 800, at least 1 500, or at least 3 000.

Growing Au nanotubes by galvanic displacement reaction follow either of the reactions below depending on the gold complex:

Au³⁺+3Ag->Au⁰+3Ag⁺

Au⁺+Ag->Au⁰+Ag⁺

For example, growing an Au nanotube at an Ag nanowire based on pure galvanic displacement reaction has the theoretical outer: inner diameter ratio, OD/ID, based on volume calculations of approximately:

OD/ID=(1+n)^{0.5}
For Au+n=1: OD/ID=1.4
For Au³⁺n=⅓: OD/ID=1.15

It is to be understood that the inner diameter of the thick-walled Au nanotubes 100 correspond to diameter of the Ag nanowire 110. In some examples, the inner diameter of the thick-walled Au nanotubes 100 may in at least some regions become smaller than the diameter of the Ag nanowire 110 due to gold growth occurring inside the Au nanotube before the ends of the Au nanotubes are capped.

Going from the initial nanowire to the final nanotube, as shown in FIG. 1a-c is typically performed in a solution containing a large number of nanowires and/or nanotubes. To reduce clumping of said nanowires and/or nanotubes the solution also contains some dispersing agent For example, if a plurality of Ag nanowires 110 in solution were not dispersed and ended up clumped, then growing gold evenly over said Ag nanowires 110 to form separate thick-walled capped Au nanotubes 100 may be very difficult.

In some examples, thick-walled capped Au nanotubes 100 where produced utilizing dispersing agent comprising polyvinylpyrrolidone, PVP, and/or hexadecyltrimethylammonium bromide, CTAB.

In some examples, the thick-walled capped Au nanotube has a difference between outer diameter and inner diameter of at least 10 nm, and/or the nanotube 100 has a ratio between outer diameter and inner diameter of at least 1.5, and/or the ends of the nanotube 100 are capped with Au, and/or wherein the gold content of the nanotube 100 is at least 80 wt %.

The plurality of thick-walled capped Au nanotubes may be used to form an interconnected electrically conductive network. Due to the thick and capped Au nanotubes, such a conductive network may have advantageous robust and non-deteriorating properties.

The thick-walled capped Au nanotubes 100 in FIG. 1c further relate to a solution comprising thick-walled capped Au nanotubes, wherein the solution comprises thick-walled capped Au nanotubes 100, a dispersing agent and a solvent. The dispersing agent is arranged to keep the thick-walled capped Au nanotubes 100 from clumping up during storage.

In some examples, at least 80% of Au nanotubes in said solution are capped. In some of these examples, at least 90%, at least 95%, or at least 97% of the Au nanotubes in said solution are capped. It is to be understood that an example solution comprising thick-walled capped Au nanotubes wherein 95% of Au nanotubes in said solution are capped relate to a solution with 5% cap-defective thick-walled capped Au nanotubes.

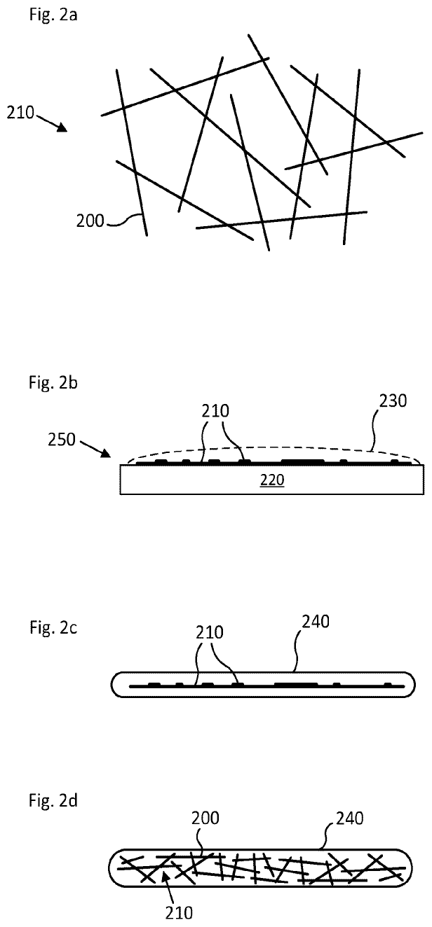

FIG. 2a-d depicts schematically electrically conductive networks of Au nanotubes in transparent electrodes. FIG. 2a shows a conductive network 210 of Au nanotubes 200 as such. FIG. 2b shows a planar substrate 220 with the conductive network 210 of Au nanotubes 200 arranged on top of said substrate 220. FIG. 2c shows the conductive network 210 of Au nanotubes 100 arranged in a plane inside a transparent polymer 240. FIG. 2d shows the conductive network 210 of Au nanotubes 200 distributed throughout the transparent polymer 240.

FIG. 2a illustrates schematically an electrically conductive network 210 of Au nanotubes 100. In some examples, the conductive network 210 of Au nanotubes is transparent and/or flexible. Typically, the Au nanotubes 100 need to be sufficiently thick and lack accessible reactive residues to retain conductivity over time and after the conductive network 210 of Au nanotubes 100 has been repeatedly bent.

In some examples, the conductive network 210 of Au nanotubes 200 comprises thick-walled capped Au nanotubes 200 according to any of the examples described in relation to FIG. 1c.

Films and composites based on electrically conductive networks 210 of thick-walled Au capped nanotubes 200 may provide one or more improved properties: high electrical conductivity, mechanical flexibility, large surface area, stability to environment, and optical transparency. In some examples, the sheet resistance of the conductive network 210 of thick-walled Au capped nanotubes 200 is at most 10 Ohm/sq. The caps of the Au nanotubes reduces absorption of solvents and chemicals during production of films and composites, compared to corresponding open Au nanotubes which may retain species within. Capped Au nanotubes formed around, for example, Ag nanowires may also reduce the leakage of any residual silver from the core.

In some examples, electrically conductive networks 210 has a weight per area of at least 0.05 mg/cm2. In some of these examples, the electrically conductive networks 210 has a weight per area of at least 0.1 mg/cm², at least 0.2 mg/cm², at least 0.4 mg/cm², at least 0.8 mg/cm², or at least 1.5 mg/cm².

In some examples, the sheet resistance of the conductive network 210 of thick-walled Au capped nanotubes 200 is at most 0.1 Ohm/sq, at most 1 Ohm/sq, or at most 100 Ohm/sq.

In some examples, the sheet transmittance at 550 nm for the conductive network 210 of thick-walled Au capped nanotubes 200 is at least 50%, at least 70%, at least 80%, at least 90%, at least 95%, or at least 97%.

In a preferred embodiment, electrically conductive network 210 of Au nanotubes 100 has sheet geometry and may be planar or nonplanar. It is to be understood that sheet geometry relates to the macroscopic geometry of the conductive network 210.

FIG. 2b illustrates schematically a substrate 220 with an electrically conductive network 210 of Au nanotubes 200 placed on top of it.

In some examples, the conductive network 210 is fixed to the substrate 220 with a binder. In some of these examples, at least part of the conductive network 210 fixed with the binder is accessible, such as being accessible to electrically connect to with external electronics.

In some examples, the conductive network 210 of Au nanotubes is encapsulated by an encapsulating layer 230.

In some examples, the substrate 220, the binder, and/or the encapsulating layer 230 are transparent. In some of these examples, transparent in the visual spectrum.

In some examples, the substrate 220, the binder, and/or the encapsulating layer 230 are flexible.

In some examples, the substrate 220, the binder, and/or the encapsulating layer 230 are electrical insulators.

In some examples, the surface of the substrate 220 at which the conductive network 210 of Au nanotubes 200 is arranged is a planar surface.

In FIG. 2b substrate that comprises the encapsulating layer 230 is shown as having the conductive network 210 of Au nanotube be completely surrounded the substrate 220 and the encapsulating layer 230. Typically, at least one part of said conductive network 210 of Au nanotubes is connected to an external conductor and/or external electronics.

In some examples, at least two separate areas of the conductive network 210 of Au nanotubes 200 are accessible.

A transparent Au nanotube electrode, wherein the transparent electrode comprises a substrate 220 and thick-walled capped Au nanotubes 200 according to the thick-walled capped Au nanotube 100 in FIG. 1c, and wherein the composite comprises an electrically conductive network 210 of said thick-walled capped Au nanotubes 200.

FIG. 2b further relates to an electrode 250 comprising a substrate 220 and the electrically conductive network 210 of Au nanotubes 200, wherein said conductive network 210 of Au nanotubes 200 is arranged on or at the substrate 220.

In some examples, the electrode 250 is a transparent electrode and the substrate 220 and conductive network 210 are both transparent for at least some range of the electromagnetic spectrum.

In some examples, the sheet transmittance at 550 nm for the electrode 250 is at least 50%, at least 70%, at least 80%, at least 90%, at least 95%, or at least 97%.

FIG. 2c illustrates schematically a layer of electrically conductive network 210 of Au nanotubes at least partially inside a flexible and transparent polymer 240.

In some examples, the layer of conductive network 210 of Au nanotubes is a planar layer.

In some examples, the sheet transmittance at 550 nm for the polymer comprising the conductive network 210 is at least 50%, at least 70%, at least 80%, at least 90%, at least 95%, or at least 97%.

In some examples, the polymer 240 comprises an elastomer. In some of these examples, the polymer 240 comprises silicone polymer, and/or polydimethylsiloxane, PDMS.

In some examples, the polymer 240 is an elastomer.

In FIG. 2c the electrically conductive network 210 of Au nanotubes is shown as completely surrounded by the polymer 240. Typically, at least one part of said conductive network 210 of Au nanotubes is connected to a conductor, such as a wire connected to an external electronic device.

In some examples, at least two separate areas of the conductive network 210 of Au nanotubes are accessible.

Au nanotube composite, wherein the composite comprises a polymer 240 and thick-walled capped Au nanotubes 200 according to the thick-walled capped Au nanotube 100 in FIG. 1c, and wherein the composite comprises an electrically conductive network 210 of said thick-walled capped Au nanotubes 200.

FIG. 2d illustrates schematically an electrically conductive network 210 of Au nanotubes 200 distributed throughout a flexible and transparent polymer 240.

In some examples, the sheet transmittance at 550 nm for the polymer 240 comprising the conductive network 210 is at least 50%, at least 70%, at least 80%, at least 90%, at least 95%, or at least 97%.

In some examples, the polymer 240 and conductive network 210 of Au nanotubes 200 form a composite material. In some examples, said composite material is in the shape of films, strips, and/or rods. In some of these examples, said films, strips, and/or rods are at most 100 μm thick or 100 μm in diameter.

In some examples, the polymer 240 and conductive network 210 of Au nanotubes 200 have been mixed so as to make said Au nanotubes 200 homogenously distributed throughout the polymer 240.

In some examples, at least two separate areas of the conductive network 210 of Au nanotubes are accessible.

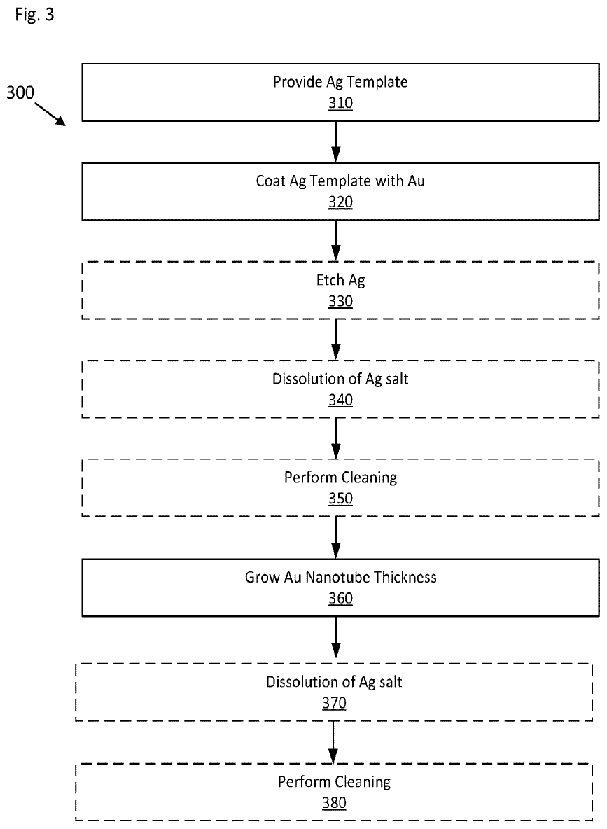

FIG. 3 illustrates a method for producing thick-walled capped Au nanotubes utilizing metal nanowires, wherein the metal nanowires are Ag nanowires. The method 300 comprises the steps of
a. forming 310 a first solution comprising Ag nanowires, and a first solvent;
b. adding 320 a first Au complex to the first solution, thereby inducing galvanic displacement of silver by gold, and/or chemical reduction of said first Au complex to coat the Ag nanowires with gold to form Au nanotubes around the Ag nanowires;
c. adding 360 a second Au complex, a growth directing agent to the first solution, thereby growing gold at the Au nanotubes to form the thick-walled capped Au nanotubes; wherein growing gold on the Au nanotubes after step c 360 is maintained for at least 1 min; wherein a dispersing agent is added to the first solution in step a and/or step b; and wherein a reducing agent is added to the first solution in step a, step b and/or step c.

The method of FIG. 3 further relates to a corresponding method utilizing Cu nanowires, or nanowires comprising silver and copper.

It is to be understood that the dispersing agent will typically need to be comprised in the first solution at least after step b is completed in order to avoid nanowires and/or nanotubes clumping up. The best way to introduce the dispersing agent may depend on the choice of the Ag nanowires and the first Au complex. For example, the Ag nanowires may require a dispersing agent upon formation of the first solution.

In some examples, dispersion agent is added upon forming 310 the first solution, and added in step c 360. Typically, dispersion agent is added if significant volumes of liquid are added to the first solution in order maintain a desirable concentration of said dispersion agent.

It is to be understood that the reducing agent will typically need to be comprised in the first solution at least after step c is completed in order to achieve sufficient gold growth. The best way to introduce the reducing agent may depend on the choice of the Ag nanowires and the first Au complex. In one example, adding the first Au complex to the first solution in step b 320 may result in sufficient galvanic displacement to coat the Ag nanowires with gold to form Au nanotubes. In another example, adding the first Au complex to the first solution in step b 320 may further require adding the reducing agent to adequately coat the Ag nanowires with gold to form Au nanotubes.

In some examples, step b induces galvanic displacement of silver by gold. In some of these examples, reducing agent is added to the first solution in step a and/or step b, inducing galvanic displacement of silver by gold, and chemical reduction of said first Au complex. It is possible to form the Au nanotube formed around an Ag nanowire shown in FIG. 1b with only galvanic displacement, however, it is typically preferable to utilize a reducing agent to improve and/or speed up gold growth.

In a preferred embodiment of the method, step c comprises reducing agent is added to the first solution. Typically, adding reducing agent in step c is desirable as opportunities for galvanic displacement may have been depleted during the gold growth following step b.

After performing either of step b or step c, growth of gold will occur at the nanowire and/or gold nanotube. Typically, it is not desirable to wait for all available species to react and the conditions in the first solution for desirable growth may change as more gold is grown, therefore the growth step may be ended by dilution of the first solution or by reducing the temperature if the growth was performed at an elevated temperature.

In some examples, the method 300 comprises a first gold growth termination step of ending the gold growth induced by step b. In some examples, the first gold growth termination step is performed at least 5 minutes after step b. In some of these examples, the amount of time between step b and performing the first gold growth termination step is at least 10 minutes, at least 20 minutes, or at least 30 minutes.

In some examples, the method 300 comprises a second gold growth termination step of ending the gold growth induced by step c. In some examples, the second gold growth termination step is performed at least 5 minutes after step c. In some of these examples, the amount of time between step c and performing the second gold growth termination step is at least 10 minutes, at least 20 minutes, or at least 30 minutes.

In some examples, the second gold growth termination step is performed when at least 80% of the grown Au nanotubes are capped. In some of these examples, the second gold growth termination step is performed when at least 90%, at least 95%, or at least 97% of the grown Au nanotubes are capped. It is to be understood that in some example methods the time for performing the second gold growth termination step may be estimated based on empirical information, in situations where directly measuring the fraction of capped Au nanotubes during the gold grown is not viable.

In some examples, the first and/or second gold growth termination step comprises diluting the first solution, thereby reducing or stopping the gold growth. In some of these examples, diluting the first solution comprises adding an amount of liquid to the first solution that is at least 50%, at least 100%, at least 200%, or at least 400% of the volume of the first solution.

In some examples, the first and/or second gold growth termination step comprises adding an oxidation agent to react with remaining reducing agent, thereby reducing or stopping the gold growth. Examples of oxidation agents are hydrogen peroxide and sodium hypochlorite.

In some examples, the first and/or second gold growth termination step comprises adding an acid and/or base to change the pH, thereby reducing or stopping the gold growth. It is to be understood that the first gold growth termination step may be described as comprised in step b, and the second gold growth termination step may be comprised in step c. The first and second gold growth termination step were not described as comprised in step b and step c in examples primarily to more clearly formulate examples describing the time between step b/c and the first/second gold growth termination step.

In some examples, the Ag nanowires have the shape of a pentagonal prism and/or a cylinder.

In some examples, the produced thick-walled capped Au nanotubes are thick-walled capped Au nanotubes as described by the examples relating to FIG. 1c.

In some examples, are nanowires according to the nanowire 110 described by the examples relating to FIG. 1a. thick-walled capped Au nanotubes as described by the examples relating to FIG. 1c.

In some examples, the first Au complex and/or the second Au complex comprise at least one gold salt. It is to be understood that the first Au complex and/or the second Au complex each can comprise one or more Au complexes, and the first Au complex and/or the second Au complex may be different.

In some examples, the first Au complex and/or the second Au complex comprises
gold (III) chloride, HAuCl₄,
gold (III) sulfate, Au₂(SO₄)₃,
gold (III) nitrate, Au(NO₃)₃,
gold (III) perchlorate, Au(ClO₄)₃,
gold (III) trifluoroacetate, Au(CF₃COO)₃,
gold (III) chloride trihydrate, AuCl₃,
gold (III), nitrate, Au(NO₃)₃,
gold (III) sulfate, Au₂(SO₄)₃,
gold (III) bromide, AuBr₃,
gold (III) perchlorate, Au(ClO₄)₃,
gold (III) trifluoroacetate, Au(CF₃COO)₃,
gold(III) hydroxide, Au(OH)₃,
sodium gold(I) sulfite, Na₃Au(SO₃)₂,
potassium gold(I) sulfite, K₃Au(SO₃)₂,
ammonium gold(I) sulfite, NH₄Au(SO₃)₂,
sodium gold(I) thiosulfate, Na: [Au(S₂O₃)₂], and/or any derivatives thereof, such as hydrates.

It is to be understood that in solutions containing hydroxide, OH⁻, some gold complex may substitute in hydroxide thus changing from the initially introduced form. For example, gold chloride may in an aqueous high pH environment substitute all Cl⁻ for OH⁻ thus becoming gold hydroxide.

In some example, the first solvent comprises H₂O, ethanol EtOH, isopropyl alcohol IPA, 1-propanol, dimethylformamide DMF, N,N-dimethylacetamide DMAc, methanol, ethylene glycol, propylene glycol, and/or acetone isopropanol.

In some examples, the first solution is formed comprising the reducing agent in step a 310.

In some examples, the reducing agent comprises lactic acid, folic acid, ascorbic acid, ascorbate, chitosan, hydroxylamine, hydroquinone, 2-pyrrolidone, sodium citrate, sodium borohydride, sodium metabisulfite, copperas (Iron II Sulfate), formaldehyde, hydrazine sulfate, and/or 2-pyrrolidone.

It is to be understood that the reducing agent added at step a, step b and/or step c may be different reducing agents and/or combinations of reducing agent.

In some examples, step b 320 comprises adding the first Au complex and the reducing agent to the first solution. In some examples, the first Au complex comprises tetrachloroauric acid, HAuCl₄, and the reducing agent comprises sodium citrate. In some examples, the first Au complex comprises tetrachloroauric acid, HAuCl₄, and the reducing agent comprises ascorbate. In some examples, the first Au complex comprises tetrachloroauric acid, HAuCl₄, and the reducing agent comprises hydroxylamine. In some examples, the first Au complex comprises gold(I) sulfite, Au(SO₃)₂³⁻, and the reducing agent comprises ascorbate. In some examples, the first Au complex comprises gold(I) sulfite, Au(SO₃)₂³⁻, and the reducing agent comprises hydroxylamine. In some examples, the first Au complex comprises gold(I) sulfite, Au(SO₃)₂³⁻, and the reducing agent comprises sodium citrate.

After step b 320 gold of the first Au complex may displace silver and form a layer of gold at the silver nanowires, however, the growth of gold is typically improved by including a separate reducing agent arranged to reduce the gold complex and form solid gold. Typically, once readily available silver has been consumed/removed a reducing agent will be required to keep growing gold from gold complex, such as after step c 360 when the second Au complex has been added.

In some examples, the first Au complex is arranged to induce galvanic displacement of its gold with silver of the Ag nanowire.

In some examples, the reducing agent comprises Na₂SO₃ and ascorbate. In some of these examples, the first solution is formed 310 comprising ascorbate and the Na₂SO₃ is added in the step b 320. In some of these examples, a second solution is formed with the Na₂SO₃ and the first Au complex in a solvent, and the second solution is added to the first solution.

It is to be understood that it may be favourable to keep one or more reducing agents separate from the Ag nanowire, first Au complex, and/or each other prior to adding them all together in step b 320.

In some situations reducing agents, such as Na₂SO₃, may complex with some Au complexes and at least partially reduce the Au, thereby facilitating further reduction to form solid gold.

In some examples, step b 320 comprises forming a second solution comprising the first Au complex, and/or the reducing agent and a second solvent, and adding said second solution to the first solution. In some of these examples, the second solution comprises a dispersing agent.

It is to be understood that the dispersing agent may be added for the first time to the first solution in step b 320. Preferably, the dispersing agent is added already in step a 310 when forming 310 the first solution to keep the silver nanowires dispersed. Typically, some type of dispersing agent will be required to successfully grow separate gold nanotubes.

In some examples, the dispersing agent comprises polyvinylpyrrolidone, PVP, and/or glycine. For example, when using polyvinylpyrrolidone as dispersing agent it may be preferable to use at least 5 wt % polyvinylpyrrolidone in the first solution.

In some examples, solution after step b and/or step c comprises at least 1 wt % dispersing agent. In some of these examples, the amount of dispersing agent is at least 2 wt %, at least 5 wt %, at least 7 wt %, or at least 10 wt %. It is to be understood that the expression “after step b and/or step c” relates to at least part of the period of the gold growth after the corresponding step.

In some examples, growing gold after step c 360 is maintained for at least 1 min. In some of these examples, growing gold after step c 360 is maintained for at least 2 min, at least 5 min, at least 10 min, at least 20 min, at least 30 min, at least 60 min, or at least 120 min.

In some examples, growing gold after step c 360 is maintained for at most 120 min

In some examples, growing gold after step c is at least partially performed with the solution at a temperature of 30-100 °C. In some examples, said solution temperature is at least 40 °C, at least 50 °C, at least 60 °C, or at least 70 °C

In some examples, growing gold after step b is at least partially performed with the first solution in the pH range 4-13. In some examples, said pH range is 5-12, 6-11, 7-10, and/or 8-9.

In some examples, growing gold after step c is at least partially performed with the solution in the pH range 1-12. In some examples, said pH range is 1-4, 3-7, 4-10, 5-9, and/or 6-8.

In a preferred embodiment of the method, the growing gold after step c is performed with the solution around the pH 7 and with HAuCl₄ as the second gold complex.

It is to be understood that solution pH has an impact on gold growth, both for rate and for the morphology of gold grown, however, ideal pH for desired growth depends on multiple factors, such as gold complex, reduction agent, solvent, and the metal of the nanowires. Furthermore, the pH may also impact the function of the dispersing agent and other species in the first solution that in turn impacts the Au nanotubes aggregation, the gold growth, and the forms taken by the metal of the nanowires.

In some examples, wherein the growth directing agent comprises polyvinylpyrrolidone, 2-pyrrolidinone, N-Methyl-2-pyrrolidone, hexadecyltrimethylammonium bromide, chloride ion, iron ion, L-arginine, and/or 1-Ethyl-2-pyrrolidone.

In some examples, polyvinylpyrrolidone of molecular weight (Mw) from 0.3 kDa to 3000 kDa is used as the growth directing agent. In some of these examples, the with polyvinylpyrrolidone of molecular weight is at least 3 kDa.

In some examples, at least one growth directing agent is added in step a and/or step b.

In some examples of the method 300, comprises, after step b 320, adding 330 an Ag etch to the first solution, thereby removing residual Ag. In some of these examples, the first acid comprises include ferric nitrate, ammonium hydroxide, and hydrogen peroxide.

It is to be understood that a large number of chemicals are suitable for etching silver, and many molecules may form complexes with silver.

In some examples of the method 300, comprises, after step b 320, adding 340 a first silver complexing agent, thereby induce dissolution of any silver salts. In some of these examples, the first silver salt dissolver comprises ammonia, cyanide, triphenylphosphine, thiosulfate, and thiocyanate. In some examples utilizing a copper nanowire, ethylenediaminetetraacetic acid is used as a copper complexing agent. Typically, dissolution of any silver salts or copper salts is performed in an aqueous solution. In some examples, adding 340 the first silver complexing agent comprises replacing the solvent of the first solution.

Adding 330 an Ag etch and adding 340 a first silver complexing agent relate to removing accessible silver and silver salts from the Au nanotubes before adding the second Au complex, thereby allowing utilizing chemicals and conditions for which silver or silver salts may have interfered. In some examples, the Ag etch forms Ag salts that the first silver complexing agent dissolves.

In some examples of the method 300, comprises, after step b 320, performing 350 dialysis, sedimentation and solvent exchange, and/or centrifugation solvent exchange, thereby cleaning the Au nanotube.

In a preferred embodiment of the method, step b 320 and step c 360 are separated by a step of replacing 350 most or all of the liquid in the first solution, whereby gold growth after step c 360 is a separate gold growth and not a direct continuation of the gold growth after step b 320. Etching 330 the metal of the nanowire or dissolving 340 any salts of the nanowire between step b 320 and step c 360 further separates the processes of forming Au nanotubes around nanowires, and forming thick-walled capped Au nanotubes.

By replacing the solvent in the first solution before adding the second Au complex, allows for utilizing chemicals and conditions for which non-nanotube components of the first solution may have interfered. It is to be understood that adding additional dispersing agent may be required to avoid clumping up of nanotubes after or during a solvent exchange.

In some examples, the reducing agent comprises 2-pyrrolidone. In some examples, the reducing agent added in step c 360 comprises 2-pyrrolidone.

In some examples, the reducing agent comprises commercial PVP comprising polyvinylpyrrolidone and 2-pyrrolidone residues, thus serving as both the dispersing agent and as the reducing agent.

In some examples of the method 300, comprises, after step c 360, adding 370 a second silver complexing agent, thereby induce dissolution of any silver salts at the thick-walled capped Au nanotubes. In some of these examples, the second silver salt dissolver comprises ammonia, cyanide, triphenylphosphine, thiosulfate, and thiocyanate. Typically, dissolution of any silver salts or copper salts is performed in an aqueous solution. In some examples, adding 370 the second silver complexing agent comprises replacing the solvent of the first solution.

In some examples of the method 300, comprises, after step c 360, performing 380 dialysis, sedimentation and solvent exchange, and/or centrifugation solvent exchange, thereby cleaning the capped Au nanotube.

It is to be understood that the thick-walled capped Au nanotubes as such may fully formed before performing 380 dialysis, sedimentation and solvent exchange, and/or centrifugation solvent exchange. However, said thick-walled capped Au nanotubes would typically not be considered a product until they were cleaned and/or extracted from the solution in which they were grown.

In some examples, the method comprises, after step c 360, adding an Ag etch to the first solution, thereby removing residual Ag. In some of these examples, the first acid comprises include ferric nitrate, ammonium hydroxide, and hydrogen peroxide.

It is to be understood that etching metal of the nanowire and/or dissolving 370 metal salts after step c allows undesirable species to become soluble, and thereafter performing solvent replacement performing 380 allows said undesirable species to be removed from the first solution and the Au nanotubes.

The invention further relates to thick-walled capped Au nanotubes obtainable by process according to any of the method examples described for FIG. 3. In some examples, obtained thick-walled capped Au nanotubes have a difference between outer diameter and inner diameter of at least 10 nm, and/or a ratio between outer diameter and inner diameter of at least 1.5, and/or a gold content of at least 80 wt %.

In some examples, the process produces thick-walled capped Au nanotubes wherein at least 80% of the grown Au nanotubes are capped. In some of these examples, at least 90%, at least 95%, or at least 97% of the grown Au nanotubes are capped.

The thick-walled capped Au nanotubes obtainable by process may be thick-walled capped Au nanotubes as described by the examples relating to FIG. 1c.

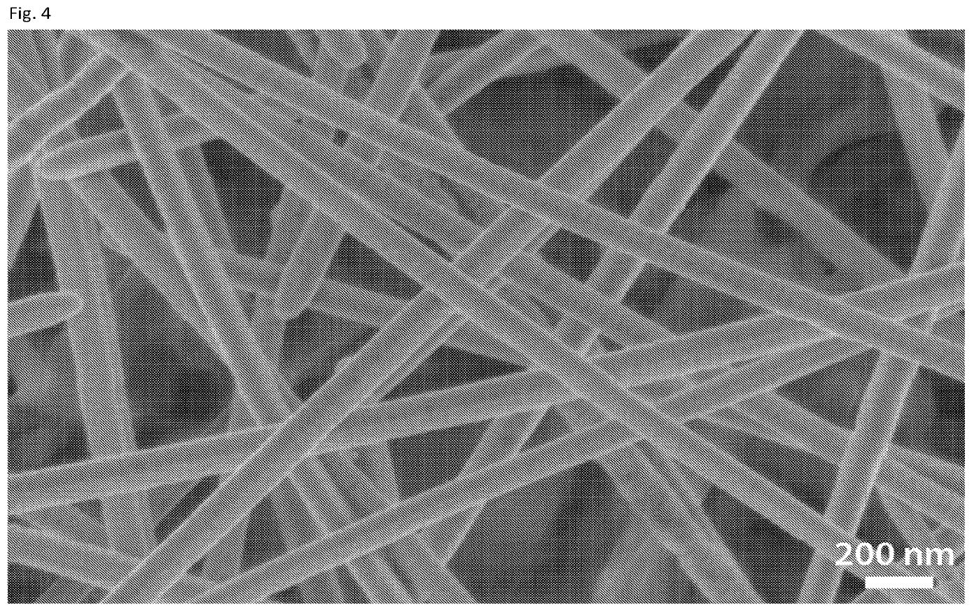

FIG. 4 depicts a SEM image of Au nanotubes, showing the thick-walled capped Au nanotubes with smooth surfaces and capped ends. The rounded ends and smooth surfaces are indicative of a nanotube structure able to protect the environment from any residual metal from the nanowire templates. The thick-walled capped Au nanotubes in the image are approximately 100 nm in diameter, thus providing a significantly more robust Au nanotube compared to the Au nanotube formed around an Ag nanowire shown in FIG. 1b.

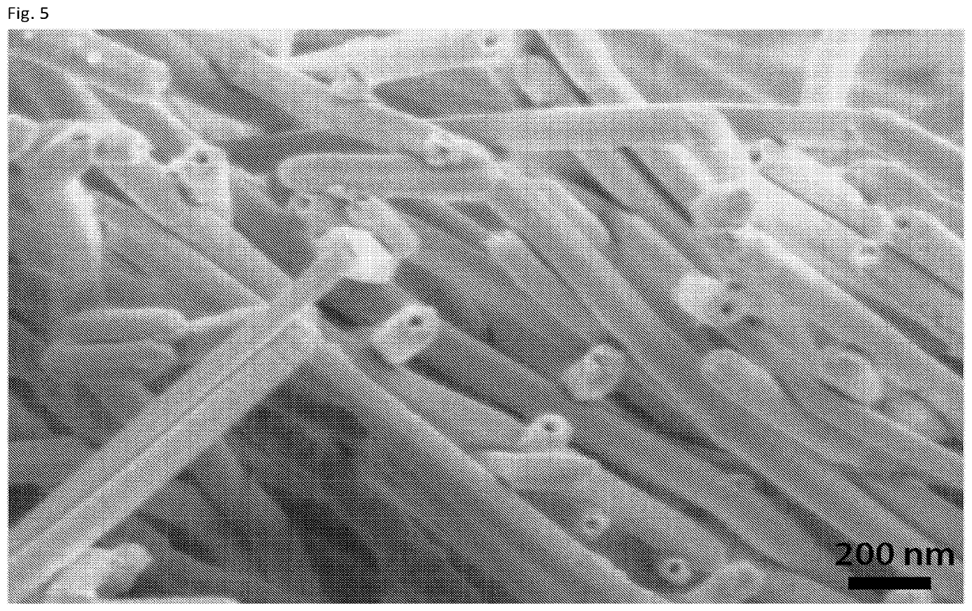

FIG. 5 depicts a SEM image of Au nanotubes, showing thick-walled capped Au nanotubes broken after being produced and revealing their inner hollow core. Approximate inner and outer diameters of at least some thick-walled capped Au nanotubes in the image appear to be approximately 20 μm and 100 μm, corresponding to an OD/ID of 5.

Example production steps for producing Au nanotubes, characterization of said Au nanotubes, integrating said Au nanotubes as electrically conductive networks in devices, and characterization of said electrically conductive networks.

### Preparing the Au Complex Precursor

68 ul HAuCl₄ was diluted with 4.173 ml of DI water.
606 ul of NaOH (1 M in DI water) was added at room temperature and then
stirred in the water bath at 60 °C for 15 min in darkness. The solution will appear in faintly green yellow colour and
solution is cooled under running cold tap water for 5 minutes.
Carefully 2.911 ml of Na₂SO₃ (0.1 M in DI water) are added and the
solution is stored in darkness for 24 hours. The Au complex precursor is observed as colourless.

### Au Coating of Ag Nanowire Template

Commercial Ag nanowires (0.793 ml of 5 mg/ml solution, 12 um length, 20 nm width) are dispersed in 4.996 ml DI water and 5.271 ml polyvinylpyrrolidone, PVP, solution (55 k molecular weight, 25 wt % in DI water) under stirring.
Glycine buffer is produced by adding 2.5 ml glycine solution (0.2 M in DI water), 0.386 ml NaOH (1 M in DI water) and 7.114 ml DI water).
To the Ag nanowire solution 600 ul of glycine buffer, 194 ul Na₂SO₃ (0.1 M in DI water) and 388 ul of Na ascorbate (1 M in DI water) are added.
The Au complex precursor is added to the stirring Ag nanowire solution and let stir in darkness for 20 minutes, thereby coating the Ag nanowire.
The Au coated Ag nanowire solution is diluted with 7 ml DI water per 1 ml nanowire solution and kept for sedimentation in darkness for one week.
The solute is redispersed in 6 ml DI water and 0.4 ml PVP (55 k molecular weight, 25 wt % in DI water) per 1 ml replaced previous solvent.

### Growth of Thick-Walled Gold Nanotubes

For the Au solution 4.24 ul HAuCl₄ (30 wt % in dilute HCl) is diluted in 3.875 ml DI water.
2.5 ml of Au coated Ag nanowire solution are added to 2.636 ml PVP (55 k molecular weight, 25 wt % in DI water) and
heated for 5 minutes in the water bath at 60 °C
The Au solution is added to the heated nanowire solution, hereafter called the Au nanotube solution, and
under continued stirring heated for 4 hours in the water bath.

Herein the commercial PVP in DI water comprises 2-pyrrolidone residues, such that the PVP and 2-pyrrolidone residues may function as reduction agent, dispersing agent and growth directing agent during the growth of thick-walled capped Au nanotubes.

### Au Nanotube Cleaning

To dissolve AgCl particles 45 ul of NH 3 solution (0.5 M in DI water) is added per 1 ml Au nanotube solution under stirring.
For solvent replacement 18 ml of Au nanotube solution and 10 ml DI water are added to a vortex tube.
The Au nanotube solution is centrifuged at 1750 rpm for 5 minutes to sediment to Au nanotubes and replace 15 ml of solvent with 15 ml of DI water.
The nanotubes are redispersed by vortexing. This is repeated once and
for the third sedimentation, the Au nanotube solution is centrifuged at 1500 rpm for 5 minutes and 15.9 ml of solvent are replaced by 5 ml of DI water to have the Au nanotubes dissolved in the same volume as directly after the reaction before the cleaning steps.
The Au nanotube solution is kept in darkness at room temperature.

### Au Nanotube Characterization

Au nanotube morphology was imaged using SEM (Sigma 500, Zeiss) and TEM (FEI Titan3 60-300). For diameter analysis, nanowires were filtered on PVDF membranes and washed with DI water. SEM images in two different areas of each sample were taken and 4 nanotube diameters in each image were measured to calculate a mean and standard deviation value.

Elemental analysis was ordered external using Inductively Coupled Plasma Sector Field Mass Spectrometry (ICO-SFMS). UV-vis absorption was measured with Absorption Spectrometer Lambda 900 (PerkinElmer).

### H₂O₂ Corrosion Testing

Au nanotubes and Ag nanowires solutions each with 0.1335 mg nanotubes per 1 ml solution were separately mixed with the same volume hydrogen peroxide solution (5 wt %) and kept for 1 hour at room temperature. Both solutions were analysed with UV-vis absorption measurements (Absorption Spectrometer Lambda 900 PerkinElmer) in comparison to the same nanotube/nanowire solutions dispersed in the same volume of DI water. The nanowire hydrogen peroxide solutions were filtered on PVDF membranes and washed with DI water and imaged with SEM (Sigma 500, Zeiss) for observation of morphology changes.

### Test Device Fabrication

Stretchable Au nanotube composite electrodes for electromechanical testing were fabricated as previously described for Au-TiO 2 nanotubes in (Lienemann et al. 2021) (Tybrandt et al. 2018). Wax patterned vacuum filtration (Tybrandt and Voros 2016) was used to pattern Au nanotube tracks (20 mm length, 0.5 mm width) with contact pads on each end (22 mm² total area per device, see figure) on a poly(vinylidene difluoride) filter membrane. Dependent on the nanowire density 0.75 ml, 1.5 ml or 3 ml of Au nanotube solution were used per device (4-8 device on one filter) in the filtration to produce approximately 1.5 um, 3 um and 5 um thick tracks. The Au nanotube structures were transferred to polydimethylsiloxane (PDMS) Sylgard 184 (Dow Corning, 10:1) or Dragon Skin (DS) 10 Slow (Smooth-On, 1:1). First, an 80 um thick bottom layer Sylgard is spincoated at 1800 rpm for 30 s (for DS 3000 rpm for 30 s) on a 2 inch silanized (Trichloro(1H,1H,2H,2H-perfluorooctyl) silane) glass wafer. The elastomer is semi-cured until the material solidified but remained sticky on a hotplate at 70 °C for around 9 minutes for Sylgard (at room temperature for around 10 minutes for DS). The patterned Au nanotubes on a filter membrane were put onto the semi-cured PDMS without applying force and then cured further on the hotplate at 70 °C with a 500 g weight applied for 8 minutes. The Au nanotubes were transferred to the elastomer by wetting the filter membrane with DI water and peeling it off leaving behind the nanowire structures. To infiltrated the nanowire network, an intermediate layer of heptane: Sylgard solution (20:1 weight ratio, same for DS) was spincoated at 6000 rpm for 60 s and cured for 5 minutes at 70 °C (around 3 minutes for DS). For the encapsulation layer additional 80 um Sylgard was spincoated at 1800 rpm for 30 s (for DS 3000 rpm for 30 s) for electromechanical test structures while the contact sites were covered by foil (poly(ethylene naphthalate), Teonex, 25 μm thick). The foil was removed directly after spin-coating and Sylgard samples were fully cured at 70 C overnight (DS samples at 70 °C for 2 hours). For pure Sylgard or DS samples without nanowires the bottom layers were spincoated as above and cured similarly before adding an encapsulation with the same parameters.

### Electromechanical Characterization

Linear Strain experiments measuring resistance used a motorized stage (X-LSQ300AE01, Zaber) and simultaneous measurement of the resistance by a Keithley 2701 digital millimetre. The 20 mm long and 0.5 mm wide samples were strained to rupture at a speed of 0.2 mm/s and cycled to 20%, 50% and 100% strain at 2 mm/s for 500 cycles respectively. For stress strain measurements a motorized linear stage (X-LSQ300A-E01, Zaber) and a force gauge (Mark-10 M5-2) were used. Samples both with and without nanowires were cut into a dumbbell shape that corresponded to the ISO 37-4 shape for tensile testing reduced to two thirds of the original size (to accommodate the very large maximum strain of DS samples in the limits of the linear stage) using a UV pulsed laser (MetaQuip Laser engraving machine FMHUV3W). The samples were mounted with a 12 mm length strained between the clamps at 0.12 mm/s linearly to rupture are cyclically for Sylgard samples with increasing strain to 20%, 50%. 100% and 150% with each cycle and DS samples to 20%, 50%, 100%, 150%, 300% and 600%.

### Characterisation of Nanowire Network

To assess crack-formation during strain cycling samples were imaged using a backlight optical microscope. After 500 cycles at 20%, 50% and 100% strain respectively samples were fixated at the maximum strain for imaging.

In an example of the above process, ultra-long AgNWs (30 nm in diameter, 150 μm long) were transformed into 150 μm long Au nanotubes of approximately 100 nm diameter. The Au nanotubes were deposited on a filter paper (0.22 mg/cm2) and transferred to a styrene-ethylene-butylene-styrene (SEBS) substrate, thus yielding a stretchable transparent electrode with an initial sheet resistance of 0.14 Ohm/square and a transmittance of the Au nanotube layer of 70% at 550 nm.

1. A method for producing thick-walled capped Au nanotubes, the method (300) comprises the steps of:
a. forming (310) a first solution comprising metal nanowires (110), and a first solvent, wherein the metal nanowires (110) is of a first metal comprising silver and/or copper;
b. adding (320) a first Au complex to the first solution, thereby inducing galvanic displacement of the first metal by gold, and/or chemical reduction of said first Au complex to coat the metal nanowires (110) with gold to form Au nanotubes (120) around the metal nanowires (110); and
c. adding (360) a second Au complex, and a growth directing agent to the first solution, thereby growing gold at the Au nanotubes (120) to form the thick-walled capped Au nanotubes (100);
wherein growing gold on the Au nanotubes after step c (360) is maintained for at least 1 min;
wherein a dispersing agent is added to the first solution in step a and/or step b; and
wherein a reducing agent is added to the first solution in step a, step b and/or step c.

2. The method according to claim 1, wherein the growth directing agent comprises polyvinylpyrrolidone, 2-pyrrolidinone, N-Methyl-2-pyrrolidone, hexadecyltrimethylammonium bromide, chloride ion, iron ion, L-arginine, and/or 1-Ethyl-2-pyrrolidone.

3. The method according to claim 1, wherein step c is performed with the solution in the pH range 1-12.

4. The method according to claim 1, wherein gold growth in step c is at least partially performed with the solution at a temperature of 30-100 °C

5. The method according to claim 1, wherein the method comprises, after step b (320), adding (330) an etchant for the first metal to the first solution, thereby removing residual first metal.

6. The method according to claim 1, wherein the method comprises, after step b (320), adding (340) a first complexing agent arranged to bind the first metal, and thereby inducing dissolution of any salts of the first metal.

7. The method according to claim 1, wherein the method comprises, after step b (320), performing (350) dialysis, sedimentation and solvent exchange, and/or centrifugation solvent exchange, thereby cleaning the Au nanotubes.

8. The method according to claim 1, wherein the method comprises, after step c (360), adding (370) a second complexing agent arranged to bind the first metal, thereby induce dissolution of any salt of the first metal.

9. The method according to claim 1, wherein the method comprises, after step c (360), performing (380) dialysis, sedimentation and solvent exchange, and/or centrifugation solvent exchange, thereby cleaning the thick-walled capped Au nanotubes.

10. Thick-walled capped Au nanotubes obtainable by process according to the method of claim 1, wherein the nanotubes (100) have a ratio between outer diameter and inner diameter of at least 1.5, and wherein the ends of the nanotubes (100) are capped with Au.

11. A thick-walled capped Au nanotube, wherein the Au nanotube (100) has a difference between outer diameter and inner diameter of at least 10 nm, wherein the nanotube (100) has a ratio between outer diameter and inner diameter of at least 1.5, wherein the ends of the nanotube (100) are capped with Au, and wherein the gold content of the nanotube (100) is at least 80 wt %.

12. A solution comprising thick-walled capped Au nanotubes, wherein the solution comprises thick-walled capped Au nanotubes (100) according to claim 11, a dispersing agent and a solvent.

13. An Au nanotube composite, wherein the composite comprises a polymer (240) and thick-walled capped Au nanotubes (100; 200) according to claim 11, and wherein the composite comprises an electrically conductive network (210) of said thick-walled capped Au nanotubes (100; 200).

14. A transparent Au nanotube electrode, wherein the electrode (250) comprises a substrate (220) and thick-walled capped Au nanotubes (100; 200) according to claim 11, wherein the electrode (250) comprises an electrically conductive network (210) of said thick-walled capped Au nanotubes (100; 200) arranged on the substrate (220).

15. The transparent Au nanotube electrode according to claim 14, wherein the electrically conductive network (210) is partially embedded in a binder arranged to fixate the electrically conductive network (210) at the substrate (200), and wherein the electrically conductive network (210) is at least partially accessible from the environment.
